(19) United States
(12) Patent Application Publication
(10) Pub. No.: US 2026/0231984 A1
(43) Pub. Date: Aug. 13, 2026

(54) LOW-MOISTURE PET FOOD COMPOSITIONS

(71) Applicant: MARS, INCORPORATED, McLean, VA (US)

(72) Inventors: Guy HEATH, West Yorkshire (GB); Genevieve BOALER-MORRISON, West Yorkshire (GB); Robert LEANEY, West Yorkshire (GB); Sarah BELT, West Yorkshire (GB)

(73) Assignee: MARS, INCORPORATED, McLean, VA (US)

(21) Appl. No.: 19/143,746

(22) PCT Filed: Dec. 29, 2023
(86) PCT No.: PCT/US2023/086499

§ 371 Date: Jun. 26, 2025

Related U.S. Application Data
(60) Provisional application No. 63/436,254, filed on Dec. 30, 2022.

(51) Int. Cl. A23K 50/42; A23K 20/147; A23K 20/158; A23K 20/163; A23K 40/25; A23K 40/30

(52) U.S. Cl. CPC A23K 50/42; A23K 20/147; A23K 20/158; A23K 20/163; A23K 40/25; A23K 40/30

(57) ABSTRACT

Low-moisture pet food compositions are provided. Such compositions can have multiple components including inner and outer components. The inner component can include a relatively soft mixture (e.g., softer than the outer component) and the outer component can include a relatively hard mixture providing for pet food compositions having a dual texture. The outer component has a low total moisture content and partially covers the inner component.

### 1. CROSS-REFERENCE TO RELATED APPLICATIONS

This application claims the benefit of priority to U.S. Provisional Patent Application Ser. No. 63/436,254 filed on Dec. 30, 2022, the content of which is incorporated herein by reference in its entirety.

### 2. FIELD

The present disclosure relates to food compositions, and more particularly to pet food compositions having low moisture and processes of manufacturing the same. Such compositions can have multiple components and a dual texture.

### 3. BACKGROUND

Dry or low-moisture pet food products are convenient and widespread means for feeding pets. Such pet food products can be in the form of treats which can have a dual texture including a harder outside shell with a softer filling inside the shell. During conventional manufacturing processes, after extrusion of the outer shell, subsequent drying is needed to reduce the moisture content of the outer shell to acceptable levels resulting in excess equipment costs, manufacturing time, and energy consumption. Further, the inner filling of such pet food compositions can undesirably have a low fill within the outer shell that is not visible, and thus, improved formulations thereof are needed in the art.

Accordingly, there has been ongoing consumer demand for more visual and textural cues of fillings in manufactured pet food products in the form of treats. Further, there is a need to provide processes for manufacturing the same with reduced cost, manufacturing time, and energy consumption. The presently disclosed subject matter addresses these and other needs.

### 4. SUMMARY OF THE INVENTION

The presently disclosed subject matter provides for multi-component pet food compositions having low moisture. Such multi-component pet food compositions can include inner and outer compositions having different textures and providing a dual textured composition. The outer component partially covers the inner component and has a low moisture content.

In certain embodiments, a multi-component pet food composition is provided. The multi-component pet food composition can include an inner component and an outer component which partially covers the inner component. The inner component of the multi-component pet food composition can include one or more fat sources in an amount of from about 0% to about 60% by weight, one or more protein sources in an amount of from about 0% to about 40% by weight, and one or more carbohydrate sources in an amount from about 15% to about 70% by weight, based on the total weight of the inner component. The outer component of the multi-component pet food composition can have a total moisture content of from about 1% to about 15% and a water activity of less than about 0.75.

In certain embodiments, the outer component of the multi-component pet food has a total moisture content of from about 6% to about 10%. In particular embodiments, the inner component and outer component are present in a ratio of from about 7:3 to about 3:7. In certain embodiments, the inner component is exposed on at least two surfaces of the pet food composition. In particular embodiments, the pet food composition has a water activity of less than about 0.65.

In certain embodiments, the one or more fat sources of the inner component comprises beef tallow. In particular embodiments, the one or more protein sources of the inner component comprises animal, non-animal protein, or combinations thereof.

In certain embodiments, the multi-component pet food composition further comprises a coating disposed on at least a portion of the outer-component. In particular embodiments, the pet food composition comprises at least two segments. In certain embodiments, the pet food composition has a length of from about 5 mm to about 150 mm.

In particular embodiments, a pet food product comprises the multi-component pet food composition.

In certain embodiments, the present disclosure provides for a method of making a low moisture pet food composition, the method comprising extruding the materials to form an outer component, introducing an inner component to form a dual-component extrudate, conveying the dual-component extrudate to a cooling tunnel, and cutting and coating the extrudate to form the low-moisture pet food composition. In particular embodiments, the outer component, after the extruding step and before the introducing step, includes a moisture content of about less than about 20%, by weight of the outer component. In certain embodiments, the method does not include a step of drying the outer component or the dual-component extrudate.

The foregoing has outlined broadly the features and technical advantages of the present application in order that the detailed description that follows may be better understood.

Additional features and advantages of the application will be described hereinafter which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### 5. BRIEF DESCRIPTION OF THE DRAWINGS

FIG. 1A depicts an image of non-limiting embodiments of low-moisture pet food compositions according to the present disclosure;

FIG. 1B depicts an image of non-limiting embodiments of low-moisture pet food compositions according to the present disclosure;

FIG. 2 depicts a process diagram for methods of manufacturing low-moisture pet food compositions according to certain non-limiting embodiments;

FIG. 3A depicts a graph illustrating the results of palatability testing showing the different mean amounts eaten of each sample of pet food compositions in accordance with certain non-limiting embodiments;

FIG. 3B depicts a chart illustrating the results of palatability testing showing percentages of cats in terms of their preferences towards one or another product in accordance with certain non-limiting embodiments;

FIG. 4A depicts a graph illustrating the results of palatability testing showing the different mean amounts eaten of each sample of pet food compositions in accordance with certain non-limiting embodiments;

FIG. 4B depicts a chart illustrating the results of palatability testing showing percentages of cats in terms of their preferences towards one or another product in accordance with certain non-limiting embodiments;

FIG. 5 depicts a graph illustrating the results of palatability testing showing the different mean amounts eaten of each sample of pet food compositions in accordance with certain non-limiting embodiments;

FIG. 6 depicts an image of non-limiting embodiments of low-moisture pet food compositions according to the present disclosure;

FIG. 7 depicts an image of non-limiting embodiments of low-moisture pet food compositions according to the present disclosure;

FIG. 8A depicts an image of non-limiting embodiments of low-moisture pet food compositions according to the present disclosure; and

FIG. 8B depicts an image of non-limiting embodiments of low-moisture pet food compositions according to the present disclosure.

### 6. DETAILED DESCRIPTION

Pet food compositions and methods of manufacturing the same are provided. Such compositions advantageously have a low moisture content and can be multi-component compositions having a dual texture. The outer component of the composition can partially cover the inner component of the composition and can have a low moisture content.

For clarity and not by way of limitation, this detailed description is divided into the following sub-portions:
6.1. Definitions;
6.2. Low-moisture pet food compositions;
6.3. Methods of making low-moisture pet food compositions;
6.4. Methods of using low-moisture pet food compositions; and
6.5. Features of low-moisture pet food compositions.

### 6.1. Definitions

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to systems or processes, the term can mean within an order of magnitude, preferably within 5-fold, and more preferably within 2-fold, of a value. The term “about” in the context of moisture content (wt %) means+/−1 wt %. The term “about” in the context of water activity (Aw) means+/−0.05. The term “about” in the context of final moisture means+/−3%. The term “about” in the context of viscosity means+/−3%.

The terms “animal” or “pet” as used in accordance with the present disclosure refers to domestic animals including, but not limited to, domestic dogs, domestic cats, horses, cows, ferrets, rabbits, pigs, rats, mice, gerbils, hamsters, goats, and the like. Domestic dogs and cats are particular non-limiting examples of pets. The term “animal” or “pet” as used in accordance with the present disclosure can further refer to wild animals, including, but not limited to bison, elk, deer, venison, duck, fowl, fish, and the like.

The terms “animal feed,” “animal feed compositions,” “pet food,” “pet food article,” or “pet food composition” are used interchangeably herein and refer to a composition intended for ingestion by an animal or pet. Pet foods can include, without limitation, nutritionally balanced compositions suitable for daily feed, such as kibbles, as well as supplements and/or treats, which can be nutritionally balanced. In an alternative embodiment, the supplement and/or treats are not nutritionally balanced.

The term “carbohydrate source” includes for example without limitation, cereals, grains, corn, wheat, rice, oats, corn grits, sorghum, grain sorghum (milo), wheat bran, oat bran, amaranth, durum, semolina, or mixtures thereof.

As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

As used herein, the term “cream” or “filling” refers to the inner component of the low-moisture pet food composition.

In the detailed description herein, references to “embodiment,” “an embodiment,” “one embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The term “extruded” in reference to a composition or animal feed refers to a composition or an animal feed which has been processed by, for example, being sent through one or more extruders. Any type of extruder can be used, non-limiting examples of which include single screw extruders and twin-screw extruders.

The term “fat source” includes for example without limitation, fat from animal sources, including poultry fat, chicken fat, turkey fat, pork fat, pork lard, milk fat, ovine fat, beef tallow, beef fat, fish oil, menhaden oil, anchovy oil, or combinations thereof, as well as fat from non-animal sources, including coconut fat, palm fat, palm stearin, vegetable oils, corn oil, soy oil, cottonseed oil, palm oil, palm kernel oil, linseed oil, canola oil, rapeseed oil, olestra, or combinations thereof.

The term “multi-component composition” refers to a composition comprising more than one component. In certain embodiments, a multi-component composition comprises an inner component and an outer component. In further embodiments, a multi-component composition comprises an inner component, an outer component, and a coating.

The term “nutritionally balanced” is in reference to a composition means that the composition, such as pet food, has known required nutrients to sustain life in proper amounts and proportion based on recommendations of recognized authorities, including governmental agencies, such as, but not limited to, Unites States Food and Drug Administration's Center for Veterinarian Medicine, the American Feed Control Officials Incorporated, in the field of pet nutrition, except for the additional need for water.

The terms “palatability” or “palatable” refer to being desirable to the palate or taste. Further, the terms “palatability” or “palatable” as used herein refer to the extent to which a pet food product appeals to the palate or taste of an animal. This is suitable measured by feeding tests, e.g., difference tests or ranking tests. In certain embodiments, “palatability” can mean a relative preference for one food product over another. For example, when an animal shows a preference for one of two or more food products, the preferred food product is more “palatable”, and has “enhanced palatability” or “increased palatability”. In certain embodiments, the relative palatability of one food product compared to one or more other food products can be determined, for example, in side-by-side, free-choice comparisons, e.g., by relative consumption of the food products, or other appropriate measures of preference indicative of palatability.

The term “pet treat” refers to a composition intended for ingestion by an animal or pet periodically. Pet treats can be nutritionally balanced. In alternative embodiments, the pet treat is not nutritionally balanced.

The term “plant protein” includes for example without limitation, soybean meal, soy protein isolate, soy protein concentrate, corn gluten meal, corn protein concentrate, distillers dried grains, distillers dried grains solubles, modified versions of plant protein, or combinations thereof.

The term “protein source” refers to animal protein, animal-derived protein, plant protein, or combinations thereof.

As used herein, the term “shell” refers to the outer component of the low-moisture pet food composition.

As used herein, the term “weight percent” or “wt %” or “by weight” is meant to refer to either (i) the quantity by weight of a constituent/component in a composition as a percentage of the total weight of the composition; or (ii) the quantity by weight of a constituent/component in the material as a percentage of the weight of the final material or product.

### 6.2. Low-Moisture Pet Food Compositions

Pet food compositions of the present disclosure advantageously have low moisture post-extrusion. Such compositions can have multiple components including inner and outer components. The inner component can be relatively soft (e.g., softer than the outer component) and include a fat-based mixture. The outer component can be relatively hard and include a cereal-based mixture. Thus, low-moisture pet food compositions of the present disclosure can have a dual texture. The outer component can partially cover the inner component and in particular embodiments, the inner component can be exposed on one or more surfaces of the low-moisture pet food composition. In certain embodiments, the low-moisture pet food composition can further include a coating.

### 6.2.1. Inner Component

In certain embodiments, low-moisture pet food compositions of the present disclosure can be multi-component compositions including an inner component. Such inner component can be relatively soft (e.g., softer than the outer component). The inner component can be fat-based and can include one or more fat sources, one or more protein sources, one or more carbohydrate sources such as flours or starches, one or more emulsifiers, one or more of waxes, water, or combinations thereof.

### 6.2.1.1. Fat Sources

In certain embodiments, the inner component of the low-moisture pet food composition can include one or more fat sources. Any suitable fat source can be used in low-moisture pet food compositions of the present disclosure. For example, the one or more fat sources included in the low-moisture pet food composition can include poultry fat, chicken fat, turkey fat, pork fat, pork lard, beef tallow, beef fat, coconut fat, palm fat, milk fat, ovine fat, palm stearin, vegetable oils, corn oil, soy oil, cottonseed oil, palm oil, palm kernel oil, linseed oil, canola oil, rapeseed oil, fish oil, menhaden oil, anchovy oil, olestra, or combinations thereof. A person skilled in the art will appreciate a wide variety of fat sources are suitable for use with compositions of the present disclosure.

In certain embodiments, the inner component can include one or more fat sources in amounts of from about 0% to about 60%, from about 20% to about 60%, from about 20% to about 40%, or from about 40% to about 60% by weight based on the total weight of the inner component.

In certain embodiments, with respect to the overall pet food composition, the one or more fat sources in the inner component are present in amounts of from about 5% to about 40%, from about 10% to about 40%, from about 20% to about 40%, from about 5% to about 30%, from about 5% to about 20%, from about 5% to about 10%, from about 20% to about 30%, from about 15% to about 25%, from about 15% to about 20%, from about 20% to about 25%, from about 30% to about 40% by weight, based on the total weight of the low-moisture pet food composition.

### 6.2.1.2. Protein Sources

In certain embodiments, the inner component of the low-moisture pet food composition can include one or more protein sources. Any suitable protein sources can be used in low-moisture pet food compositions of the present disclosure. For example, protein sources included in the low-moisture pet food composition can include animal and/or non-animal protein, wheat gluten, egg protein, collagen (e.g., collagen peptides), gelatin, whey protein, caseins, soybean meal, soy protein isolate, soy protein concentrate, soy protein, corn gluten meal, protein hydrolysates, corn protein concentrate, distillers dried grains, distillers dried grains solubles, modified versions of plant protein or combinations thereof. In certain embodiments, the protein source can include meat and derivatives thereof, fish and derivatives thereof, or combinations thereof. In particular embodiments, the meat and derivatives thereof can include dried or fresh meat materials for specific species, for example, chicken, beef, lamb, duck, etc. and blends thereof. In certain embodiments, the fish and derivatives thereof can include dried or fresh fish materials for specific species such as tuna, salmon, whitefish, shrimp, etc. and blends thereof. In particular embodiments, the fish and derivatives thereof can include fish meals, bone meals, blood products, or combinations thereof from certain species.

In certain embodiments, the inner component can include one or more protein sources in amounts of from about 0% to about 40%, from about 0% to about 35%, from about 1% to about 40%, from about 1% to about 35%, from about 5% to about 40%, from about 5% to about 35%, from about 10% to about 40%, from about 15% to about 35%. Alternatively, the inner component can include one or more protein sources in amounts of from about 1% to about 10%, 1% to about 15%, from about 5% to about 15%, from about 5% to about 30%, from about 5% to about 40%, from about 10% to about 30%, from about 15% to about 35%, from about 20% to about 40%, or from about 30% to about 40% by weight based on the total weight of the inner component.

In certain embodiments, with respect to the overall pet food composition, the inner component can include one or more protein sources in amount of from about 0% to about 25%, from about 1% to about 25%, from about 5% to about 25%, from about 10% to about 25%, from about 0% to about 10%, from about 1% to about 10%, from about 5% to about 10%, or from about 10% to about 20% by weight, based on the total weight of the low-moisture pet food composition.

In certain embodiments, the low-moisture pet food compositions of the present disclosure can include protein sources in an amount of from about 5% to about 30%, from about 5% to about 20%, from about 5% to about 10% by weight, based on the total weight of the low-moisture pet food composition. Alternatively, the amount of protein sources can range from about 10% to about 30%, from about 10% to about 20%, from 20% to about 30%, from about 20% to about 25%, or from about 15% to about 20% by weight, based on the total weight of the low-moisture pet food composition. In particular embodiments, the low-moisture pet food compositions of the present disclosure can include protein sources in an amount of less than about 20%, less than about 15%, less than about 10%, or less than about 5% by weight, based on the total weight of the low-moisture pet food composition.

### 6.2.1.3. Carbohydrate Sources

In certain embodiments, the inner component of the low-moisture pet food composition can include one or more carbohydrate sources. Any suitable carbohydrate sources can be used in low-moisture pet food compositions of the present disclosure. Such carbohydrate sources can include flours, starches, or combinations thereof. For example, the low-moisture pet food composition can include wheat flour, heat treated flour, maize flour, wheat starch, maize starch, pea starch, pre-gelatinized starch (e.g., pre-gel wheat starch), native starch, maltodextrin, cereals, grains, corn, wheat, rice, oats, corn grits, sorghum, grain sorghum (milo), wheat bran, oat bran, amaranth, durum, semolina, or combinations thereof. In certain embodiments, maltodextrin or other alternatives to animal and/or non-animal protein can be used as a thickening agent to achieve a certain viscosity, thermal stability, and pet feeding performance. A person skilled in the art will appreciate a wide variety of carbohydrate sources are suitable for use in the compositions of the present disclosure.

In certain embodiments, the inner component can include one or more carbohydrate sources in amounts of from about 15% to about 70% or from 40% to about 65% by weight, based on the total weight of the inner component.

In certain embodiments, with respect to the overall pet food composition, the inner component can include one or more carbohydrate sources in amount from about 5% to about 25%, from about 5% to about 10%, from about 5% to about 15%, from about 15% to about 25%, or from about 10% to about 20%, by weight, based on the total weight of the low-moisture pet food composition.

### 6.2.1.4. Emulsifiers

In certain embodiments, the inner component of the low-moisture pet food composition can further include one or more emulsifiers. Any suitable emulsifier can be used in the low-moisture pet food compositions of the present disclosure. For example, the one or more emulsifiers can include monoglycerides, diglycerides, lecithin, or combinations thereof.

In certain embodiments, the inner component can include one or more emulsifiers in amounts of less than about 10% by weight based on the total weight of the inner component. In certain embodiments, the inner component can include one or more emulsifiers in amount of from about 1% to about 10%, from about 5% to about 10%, or from about 1% to about 5% by weight based on the total weight of the inner component. In certain embodiments, with respect to the overall pet food composition, the one or more emulsifiers can be present in the inner component in an amount of less than about 5% by weight, based on the total weight of the low-moisture pet food composition. In certain embodiments, with respect to the overall pet food composition, the one or more emulsifiers can be present in the inner component in an amount of from about 1% to about 5%, from about 2% to about 4%, or from about 1% to about 2% by weight, based on the total weight of the low-moisture pet food composition.

### 6.2.1.5. Waxes

In certain embodiments, the inner component of the low-moisture pet food composition can further include one or more waxes. Any suitable wax can be used in the low-moisture pet food compositions of the present disclosure. For example, the one or more waxes can include carnauba wax, beeswax, or combinations thereof.

In particular embodiments, the inner component can include one or more waxes in an amount of from about 0.5% to about 2.0%, about 1% to about 2%, or about 1.25% to about 1.75%, or about 1.5% by weight based on the total weight of the inner component. In certain embodiments, with respect to the overall pet food composition, the one or more waxes can be present in the inner component in an amount of from about 0.75% to about 1.50% by weight, based on the total weight of the low-moisture pet food composition.

### 6.2.1.6 Water

In certain embodiments, the inner component of the low-moisture pet food composition can further include water.

In particular embodiments, the inner component can include water in an amount of from about 0.1% to about 2.5%, about 0.15% to about 2%, or about 0.25% to about 1%, or about 0.5% by weight, based on the total weight of the inner component. In certain embodiments, with respect to the overall pet food composition, the water can be present in the inner component in an amount of about 0.25% to about 1.40%, about 0.25% to about 1%, about 1% to about 1.40% or about 0.25% to about 0.5% by weight, based on the total weight of the low-moisture pet food composition.

### 6.2.1.7. Inner Component Formulations

In certain embodiments, the inner component of the low-moisture pet food composition can include one or more protein sources, one or more carbohydrate sources, one or more fat sources, one or more emulsifier, one or more waxes, water, or combinations thereof. In particular embodiments, the inner component can include one or more fat source in an amount of from about 40% to about 60% by weight, one or more protein sources in an amount from about 0% to about 40% by weight, one or more carbohydrate sources in an amount of from about 15% to about 70% by weight, one or more emulsifiers in an amount of less than about 10% by weight, one or more waxes in an amount of from about 0.5% to about 2.0% by weight, and water in an amount of from about 0.1% to about 2.5% by weight, based on the total weight of the inner component.

In certain embodiments, the inner component of the low-moisture pet food composition can include one or more protein sources, one or more carbohydrate sources, one or more fat sources, one or more emulsifier, one or more waxes, water, or combinations thereof. In particular embodiments, the inner component of the low-moisture pet food composition can include one or more fat source in an amount of from about 45% to about 55% by weight, one or more protein sources in an amount from about 0% to about 35% by weight, one or more carbohydrate sources in an amount of from about 40% to about 65% by weight, one or more emulsifiers in an amount of less than 10% by weight, one or more waxes in an amount of from about 1% to about 2% by weight, and water in an amount of from about 0.15% to about 2% by weight, based on the total weight of the inner component.

In certain embodiments, the inner component of the low-moisture pet food composition can include one or more protein sources, one or more carbohydrate sources, one or more fat sources, one or more emulsifier, one or more waxes, water, or combinations thereof. In particular embodiments, the inner component of the low-moisture pet food composition can include one or more fat source in an amount of from about 40% to about 50% by weight, one or more protein sources in an amount from about 5% to about 30% by weight, one or more carbohydrate sources in an amount of from about 40% to about 65% by weight, one or more emulsifiers in an amount of less than about 10% by weight, one or more waxes in an amount of from about 1.25% to about 1.75% by weight, and water in an amount of from about 0.25% to about 1% by weight, based on the total weight of the inner component.

In certain embodiments, the inner component of the low-moisture pet food composition can include one or more protein sources, one or more carbohydrate sources, one or more fat sources, one or more emulsifier, one or more waxes, water, or combinations thereof. In particular embodiments, the inner component of the low-moisture pet food composition can include one or more fat source in an amount of from about 50% to about 60% by weight, one or more protein sources in an amount from about 5% to about 30% by weight, one or more carbohydrate sources in an amount of from about 40% to about 65% by weight, one or more emulsifiers in an amount of less than about 10% by weight, one or more waxes in an amount of about 1.5% by weight, and water in an amount of about 0.5% by weight, based on the total weight of the inner component.

In certain embodiments, the inner component of the low-moisture pet food composition can include one or more fat sources and one or more carbohydrate sources. In particular embodiments, the one or more fat sources can be present in an amount of from about 55% to about 60% by weight and the one or more carbohydrate sources can be present in an amount of from about 40% to about 45% by weight, based on the total weight of the inner component. In certain embodiments, the one or more fat sources can include beef tallow and the one or more carbohydrate sources can include wheat flour.

In certain embodiments, the inner component of the low-moisture pet food composition can include one or more fat sources present in an amount of from about 40% to about 55% by weight, one or more carbohydrate sources present in an amount of from about 40% to about 45% by weight, and one or more protein sources present in an amount of from about 5% to about 15% by weight, based on the total weight of the inner component. In certain embodiments, the one or more fat sources can include beef tallow, the one or more carbohydrate sources can include wheat flour, and the one or more protein sources can include animal and/or non-animal protein.

In certain embodiments, the inner component of the low-moisture pet food composition can include one or more fat sources present in an amount of from about 40% to about 45%, one or more carbohydrate sources present in an amount of from about 25% to about 35% by weight, and one or more protein sources present in an amount of from about 25% to about 30% by weight, based on the total weight of the inner component. In certain embodiments, the one or more fat sources can include beef tallow, the one or more carbohydrate sources can include maltodextrin, and the one or more protein sources can include animal and/or non-animal protein.

### 6.2.2. Outer Component

In certain embodiments, low-moisture pet food compositions of the present disclosure can be multi-component compositions further comprising an outer component. Such outer component can be relatively hard. The outer component can be cereal-based and can include one or more protein sources, one or more carbohydrate sources, one or more additional ingredients, one or more processing aids, or combinations thereof.

### 6.2.2.1. Protein Sources

In certain embodiments, the outer component of the low-moisture pet food composition can include one or more protein sources. Any suitable protein sources can be used in low-moisture pet food compositions of the present disclosure. The one or more protein sources can include a meal or powder. In certain non-limiting embodiments, the meal or powder can include animal meals or animal powders. For example, in particular non-limiting embodiments, animal meals or powders can include animal liver powder, poultry liver powder, beef liver powder, chicken powder, poultry meal (e.g., chicken by-product meal dried), beef liver powder, beef meal, spray dried mechanically deboned meat (MDM), meat meal (e.g., spray dried pork meat or sieved poultry meal), or combinations thereof. Various spray dried animal proteins are suitable for use with the present disclosure. Additionally or alternatively, the one or more protein sources can include one or more vegetable proteins such as soya fines, soya, vital wheat gluten, wheat gluten, corn gluten, maize gluten, pea protein (e.g., pea protein 75%), whey protein, or combinations thereof. A person skilled in the art would appreciate a variety of animal proteins and vegetable proteins are suitable for use with the compositions of the present disclosure. In certain embodiments, the protein source can include meat and derivatives thereof, fish and derivatives thereof, or combinations thereof. In particular embodiments, the meat and derivatives thereof can include dried or fresh meat materials for specific species, for example, chicken, beef, lamb, duck, etc. and blends thereof. In certain embodiments, the fish and derivatives thereof can include dried or fresh fish materials for specific species such as tuna, salmon, whitefish, shrimp, etc. and blends thereof. In particular embodiments, the fish and derivatives thereof can include fish meals, bone meals, blood products, or combinations thereof from certain species.

In certain embodiments, the one or more protein sources can include poultry meal. In alternative embodiments, the one or more protein sources can further include animal liver powder and wheat gluten. In another alternative embodiment, the one or more protein sources can further include pea protein and corn gluten.

In certain embodiments, the outer component of the low-moisture pet food composition can include one or more protein sources in an amount from about 0% to about 80%, about 0% to about 40%, about 1% to about 40%, about 1% to about 20%, about 40% to about 80%, about 30% to about 60%, about 20% to about 60%, or about 25% to about 45% by weight, based on the total weight of the outer component. In certain embodiments, the one or more protein sources can be one or more animal protein present in the outer component in an amount from about from about 0% to about 50%, about 15% to about 40%, or about 19% to about 36% by weight, based on the total weight of the outer component. In certain embodiments, the one or more protein sources can be one or more vegetable protein present in the outer component in an amount from about from about 0% to about 50%, about 0% to about 15%, or about 35% to about 50%, or about 15% to about 40% by weight, based on the total weight of the outer component.

In certain embodiments, with respect to the overall pet food composition, the one or more protein sources can be present in the outer component in an amount of about 0% to about 60%, about 0% to about 30%, about 1% to about 60%, about 1% to about 30%, about 30% to about 60%, about 10% to about 50%, or about 15% to about 45% by weight, based on the total weight of the low-moisture pet food composition.

In certain embodiments, the low-moisture pet food compositions of the present disclosure can include protein sources in an amount of from about 5% to about 30%, from about 5% to about 20%, from about 5% to about 10% by weight, based on the total weight of the low-moisture pet food composition. Alternatively, the amount of protein sources can range from about 10% to about 30%, from about 10% to about 20%, from 20% to about 30%, from about 20% to about 25%, or from about 15% to about 20% by weight, based on the total weight of the low-moisture pet food composition. In particular embodiments, the low-moisture pet food compositions of the present disclosure can include protein sources in an amount of less than about 20%, less than about 15%, less than about 10%, or less than about 5% by weight, based on the total weight of the low-moisture pet food composition.

### 6.2.2.2. Carbohydrate Sources

In certain embodiments, the outer component of the low-moisture pet food composition can include one or more carbohydrate sources. Any suitable carbohydrate source can be used in low-moisture pet food compositions of the present disclosure. For example, the one or more carbohydrate sources can include rice, corn, ground maize, maize flour, wheat flour, rice flour, pea starch, soy flour, potato starch, functional starches (e.g., maize, wheat, or rice), or combinations thereof. A person skilled in the art will appreciate a wide variety of starches are suitable for use in the outer component of compositions of the present disclosure.

In certain embodiments, the one or more carbohydrate sources can include rice and corn. In another alternative embodiment, the one or more carbohydrate sources can include corn and soy flour.

In certain embodiments, the one or more carbohydrate sources can be present in the outer component in an amount of from about 0% to about 75%, about 0% to about 30%, about 1% to about 75%, about 1% to about 30%, about 10% to about 45%, about 30% to about 45%, or about 45% to about 75% by weight, based on the total weight of the outer component.

In certain embodiments, with respect to the overall pet food composition, the one or more carbohydrate sources can be present in the outer component in an amount of from about 1% to about 60%, about 5% to about 60%, about 10% to about 50%, about 15% to about 40%, about 15% to about 35%, or about 20% to about 35% by weight, based on the total weight of the low-moisture pet food composition.

### 6.2.2.3. Additional Ingredients

In certain embodiments, the outer component can include one or more additional ingredients. In particular embodiments, the outer component can include one or more yeast sources (e.g., yeast, brewers, brewer's yeast, yeast brewer's pure 43% bag, or grain distillers dried yeast). In certain embodiments, the one or more yeast sources can be present in the outer component in an amount of from about 0% to about 25%, about 0% to about 5%, about 5% to about 20%, or about 5% to about 15% by weight, based on the total weight of the outer component.

In certain embodiments, the outer component can include one or more salts (e.g., calcium chloride). In particular embodiments, the one or more salts can be present in the outer component in an amount of from about 0% to about 3%, about 0.1% to about 2.5%, about 1% to about 3%, or about 1.5% to about 2% by weight, based on the total weight of the outer component.

In certain embodiments, the outer component can include additional ingredients such as active ingredients, e.g., probiotics, minerals, e.g., calcium carbonate, sodium chloride, or any other vitamins, minerals, or other substances needed for nutrition. In particular embodiments, the outer component can include one or more additional ingredients in an amount of from about 0% to about 5%, about 1% to about 5%, about 1.5% to about 5%, about 1% to about 3%, or about 1% to about 2% by weight, based on the total weight of the outer component.

### 6.2.2.4. Outer Component Formulations

In certain embodiments, the outer component of the low-moisture pet food composition can include one or more protein sources, one or more carbohydrate sources, one or more additional ingredients, or combinations thereof. In particular embodiments, the one or more protein sources can be present in an amount from about 0% to about 80% by weight, the one or more carbohydrate sources can be present in an amount of from about 0% to about 75% by weight, based on the total weight of the outer component. In particular embodiments, the one or more protein sources can be present in an amount from about 25% to about 45% by weight, the one or more carbohydrate sources can be present in an amount of from about 45% to about 75% by weight, based on the total weight of the outer component.

In particular embodiments, the one or more protein sources can be present in an amount of from about 20% to about 70% by weight, the one or more carbohydrate sources can be present in an amount of from about 30% to about 65% by weight, and the one or more additional ingredients can be present in an amount of from about 1% to about 10%, based on the total weight of the outer component. In certain embodiments, the one or more protein sources can include poultry meal (e.g., sieved poultry meal). In certain embodiments, the one or more carbohydrate sources can include rice flour and corn. In certain embodiments, the one or more additional ingredients can include sodium chloride and yeast.

In particular embodiments, the outer component of the low-moisture pet food composition can include one or more carbohydrate sources present in an amount of from about 50% to about 60% by weight, one or more animal proteins as a protein source present in an amount of from about 15% to about 25% by weight, one or more vegetable proteins as a protein source present in an amount of from about 10% to about 15% by weight, yeast present in an amount of from about 0% to about 5% by weight, and minerals present in an amount of from about 5% to about 10% by weight, based on the total weight of the outer component.

### 6.2.2.5. Outer Component Features

The outer component of pet food compositions of the present disclosure can have a moisture content of less than about 20%, less than about 15%, less than about 10%, from about 1% to about 15%, or from about 6% to about 10%.

The water activity (Aw) of the outer component of pet food compositions of the present disclosure can be from about 0.4 to about 0.75, about 0.4 to about 0.65, about 0.4 to about 0.63, about 0.4 to about 0.55, about 0.45 to about 0.5, or about 0.5 to about 0.55. In particular embodiments, the water activity (Aw) of the outer component of pet food compositions of the present disclosure is less than about 0.75, less than about 0.65, less than about 0.63, less than about 0.55, less than about 0.5, less than about 0.45, or less than about 0.4.

The low-moisture content of the outer component post-extrusion can reduce or eliminate subsequent drying load needed for the extrudate since the outer component from the extruder contains a moisture level substantially equal to that of the final product. In contrast, prior outer components can be typically extruded at about 24% to about 30% moisture and need subsequent drying to achieve the target moisture level of the final product. Thus, outer components of the present disclosure advantageously have a low moisture content. Additionally, by limiting and/or eliminating a post-extrusion drying step, the processes of the present disclosure advantageously provide for low-moisture pet food compositions with a dual-texture of outer components and visible inner components, which would otherwise melt in a post-extrusion, high temperature drying step.

### 6.2.3 Coating

In certain embodiments, low-moisture pet food compositions of the present disclosure can further include a coating. The coating can include various ingredients as known in the art. In particular embodiments, the coating can include one or more fat sources such as beef tallow and other additives such as digest palatant material.

In certain embodiments, the coating can include one or more fat sources in an amount of from about 20% to about 60%, about 20% to about 40%, about 30% to about 50%, or about 40% to about 50% by weight, based on the total weight of the coating. In particular embodiments, with respect to the overall pet food composition, the coating can include one or more fat sources in an amount of from about 1% to about 3%, about 1% to about 2%, or about 2% to about 3% by weight, based on the total weight of the low-moisture pet food composition.

In certain embodiments, the coating can include one or more additives in an amount of from about 45% to about 75%, about 55% to about 75%, about 50% to about 65%, or about 55% to about 60% by weight, based on the total weight of the coating. In particular embodiments, with respect to the overall pet food composition, the one or more additives can be present in the coating in an amount of from about 0.5% to about 5%, about 0.75% to about 4.5%, or about 1% to about 3% by weight, based on the total weight of the low-moisture pet food composition.

In certain embodiments, the coating can include one or more fat sources in an amount of from about 20% to about 60% by weight and one or more additives in an amount of from about 45% to about 75% by weight, based on the total weight of the coating. In particular embodiments, the coating can include one or more fat sources in an amount of from about 30% to about 50% by weight and one or more additives in an amount of from about 50% to about 65% by weight, based on the total weight of the coating. In certain embodiments, the coating can include one or more fat sources in an amount of from about 40% to about 50% by weight and one or more additives in an amount of from about 55% to about 65% by weight, based on the total weight of the coating.

In particular embodiments, with respect to the overall pet food composition, the coating can be present and applied in an amount of from about 1% to about 10%, about 7% to about 8%, about 1% to about 5%, or about 3% to about 5% by weight, based on the total weight of the low-moisture pet food composition. In further embodiments, with respect to the overall pet food composition, the coating can be present and applied in an amount of less than about 10%, less than about 5%, less than about 4.5%, or less than about 3% by weight, based on the total weight of the low-moisture pet food composition. The coating can be disposed on at least a portion of the outer component of the low-moisture pet food composition. In certain embodiments, the coating can be a homogenous coating. In certain embodiments, the coating can be a palatability-enhancing coating.

### 6.2.4. Additional Additives

Low-moisture pet food compositions of the presently disclosed subject matter can also contain other additives. For example, dried proteins such as meat proteins can be included in the outer component and rehydrated during the extrusion process.

### 6.2.4.1. Colorings and Flavorings

Further, inner and outer components of low-moisture pet food compositions of the present disclosure can include colorings and flavorings.

Any suitable flavorings can be used in low-moisture pet food compositions of the present disclosure, for example, fish, seafood, meat, poultry, cheese, catnip, or combinations thereof. In certain embodiments, the low-moisture pet food composition can include one or more flavorings in an amount of from about 0% to about 8%, about 0% to about 5%, about 1% to about 5%, or about 3% to about 5% by weight, based on the total weight of the low-moisture pet food composition.

Any suitable colorants can be used in low-moisture pet food compositions of the present disclosure, for example, as dry powders including dark malt, carmine, sunset yellow, natural brown, banana yellow, beta-carotene, or combinations thereof. In certain embodiments, the low-moisture pet food composition can include one or more colorants in an amount of less than about 3%, less than about 2%, less than about 1%, about 1% to about 3%, or about 1% to about 2% by weight, based on the total weight of the low-moisture pet food composition.

Further additives can include liquids in water or oil dispersed forms, for example, carmine, caramel, natural brown, banana yellow, beta-carotene, or combinations thereof. Such liquids can be present in an amount of less than about 3%, less than about 2%, less than about 1% by weight, about 1% to about 3%, or about 1% to about 2% by weight, based on the total weight of the low-moisture pet food composition.

### 6.2.4.2. Anti-Hairball Agents

In particular embodiments, the low-moisture pet food compositions of the present disclosure can include one or more anti-hairball agents. For example, such ingredients can include psyllium seed husk, slippery elm powder, lignin, cellulose, beet pulp, or combinations thereof. In particular embodiments, the low-moisture pet food composition can include one or more anti-hairball agents in an amount of from about 1% to about 10%, about 5% to about 10%, or about 3% to about 8% by weight, based on the total weight of the low-moisture pet food composition. In certain embodiments, the low-moisture pet food composition can include one or more anti-hairball agents in an amount of less than about 10%, less than about 8%, less than about 5%, less than about 3%, less than about 2%, less than about 1%, about 1% to about 10%, about 1% to about 5%, about 5% to about 10% by weight, based on the total weight of the low-moisture pet food composition. In particular embodiments, the low-moisture pet food composition can include psyllium seed husk in an amount of less than about 5% by weight, based on the total weight of the low-moisture pet food composition. In certain embodiments, the low-moisture pet food composition can include slippery elm powder in an amount of less than about 10% by weight, based on the total weight of the low-moisture pet food composition.

### 6.2.4.3. Active Ingredients

The pet food composition of the present disclosure can further include one or more active ingredients that can include, in non-limiting examples, sources of fiber ingredients, mineral ingredients, vitamin ingredients, polyphenols ingredients, amino acid ingredients, carotenoid ingredients, antioxidant ingredients, fatty acid ingredients, glucose mimetic ingredients, probiotic ingredients, prebiotic ingredients, or combinations thereof. Suitable active ingredients can include biologics, for example enzymes, antibodies, immunoglobulins, cytokines, epigenetic agents, and mixtures and combinations of these. Sources of mineral ingredients can, in non-limiting examples, include sodium selenite, monosodium phosphate, calcium carbonate, potassium chloride, ferrous sulfate, zinc oxide, manganese sulfate, copper sulfate, manganous oxide, potassium iodide, and/or cobalt carbonate. Sources of vitamin ingredients can, in non-limiting examples, include choline chloride, vitamin E supplement, ascorbic acid, vitamin A acetate, calcium pantothenate, pantothenic acid, biotin, thiamine mononitrate (source of vitamin B1), vitamin B12 supplement, niacin, riboflavin supplement (source of vitamin B2), inositol, pyridoxine hydrochloride (source of vitamin B6), vitamin D3 supplement, folic acid, vitamin C, and/or ascorbic acid. Sources of polyphenols ingredients can, in non-limiting examples, include tea extract, rosemary extract, rosemarinic acid, coffee extract, caffeic acid, turmeric extract, blueberry extract, grape extract, grapeseed extract, and/or soy extract. Sources of amino acid ingredients can include 1-Tryptophan, Taurine, Histidine, Carnosine, Alanine, Cysteine, Arginine, Methionine, Tryptophan, Lysine, Asparagine, Aspartic acid, Phenylalanine, Valine, Threonine, Isoleucine, Histidine, Leucine, Glycine, Glutamine, Taurine, Tyrosine, Homocysteine, Ornithine, Citruline, Glutamic acid, Proline, peptides, and/or Serine. Sources of antioxidant ingredients can, in non-limiting examples, include tocopherols (vitamin E), vitamin C, vitamin A, plant-derived materials, carotenoids (described above), selenium, and/or CoQ10 (Co-enzyme Q10). Sources of fatty acid ingredients can include arachidonic acid, alpha-linoleic acid, gamma linolenic acid, linoleic acid, eicosapentanoic acid (EPA), docosahexanoic acid (DHA), and/or fish oils as a source of EPA and/or DHA.

Such active ingredients can be present in an amount of from about 0.1% to about 5%, about 0.5% to about 5%, or about 1% to about 5% by weight, based on the total weight of the pet food composition. In particular embodiments, the one or more active ingredients can be present in an amount of less than about 5%, less than about 2%, less than about 1%, less than about 0.5%, or less than about 0.1% by weight, based on the total weight of the pet food composition.

### 6.2.4.4. Antioxidants

In certain embodiments, low-moisture pet food compositions of the present disclosure can include one or more antioxidants. Any suitable antioxidant can be used in the low-moisture pet food compositions of the present disclosure. For example, the one or more antioxidants can include butylated hydroxyanisole (BHA), butylated hydroxytoluene (BHT), citric acid, vitamin E, other artificial or natural antioxidants, for example, tocopherols, rosemary extract, or combinations thereof. In particular embodiments, the low-moisture pet food composition can include one or more antioxidants in an amount of from about 0% to about 3%, about 1% to about 3%, or about 2% to about 3% by weight, based on the total weight of the low-moisture pet food composition.

### 6.2.4.5. Dairy Products

In certain embodiments, low-moisture pet food compositions of the present disclosure can include one or more dairy products such as dried cheese or milk products, or combinations thereof. Any suitable dairy products can be used in the low-moisture pet food compositions of the present disclosure. For example, the low-moisture pet food composition can include cheese powder. In particular embodiments, the low-moisture pet food composition can include one or more dairy products in an amount of from about 0.1% to about 5%, about 0.5% to about 5%, or about 1% to about 5%, based on the total weight of the low-moisture pet food composition. In particular embodiments, the low-moisture pet food composition can include one or more dairy products in an amount of less than about 5%, less than about 2%, less than about 1%, less than about 0.5%, or less than about 0.1% by weight, based on the total weight of the low-moisture pet food composition.

### 6.2.4.6 Oils

In certain embodiments, the low-moisture pet food composition of the present disclosure can include one or more oils. For example, the low-moisture pet food composition can include sunflower oil, fish oils, omega-3, or combinations thereof. In particular embodiments, the low-moisture pet food composition can include one or more oils in an amount of from about 0.1% to about 2%, about 0.5% to about 2%, or about 1% to about 2% by weight, based on the total weight of the low-moisture pet food composition. In particular embodiments, the low-moisture pet food composition can include one or more oils in an amount of less than about 2%, less than about 1.5%, less than about 1%, less than about 0.5%, or less than about 0.1%, about 0.1% to about 2%, about 0.5% to about 1%, about 0.5% to about 1.5% by weight, based on the total weight of the low-moisture pet food composition.

The ingredients and their proportions of the inner and outer components of the low-moisture pet food composition can be varied to provide different properties or aesthetic characteristics. In certain embodiments, the low-moisture pet food composition can include additional excipients not disclosed or described herein.

### 6.2.5. Food Compositions

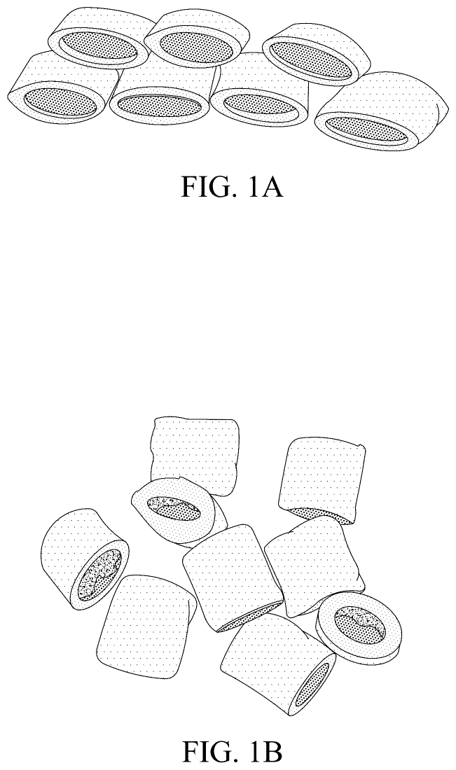

Pet food compositions of the present disclosure can be multi-component compositions including inner and outer components. FIGS. 1A and 1B provide images of non-limiting embodiments of low-moisture pet food compositions according to the present disclosure. In certain embodiments, the inner component can include one or more fat sources, one or more proteins sources, and one or more carbohydrate sources as provided herein. In certain embodiments, the outer component can include one or more protein sources, one or more carbohydrate sources, and one or more additional ingredients as provided herein. In particular embodiments, the inner component can include beef tallow, animal and/or non-animal protein, poultry liver powder, and wheat flour. In particular embodiments, the outer component can include potato starch, poultry liver powder, soya fines, sodium chloride, calcium carbonate, wheat gluten, and maize gluten. The low-moisture pet food composition can further be at least partially covered with a coating. In particular embodiments, the coating can include beef tallow and digest palatant material.

The ratio of the inner component to the outer component in the low-moisture pet food composition can be about 3:7, about 7:3, about 3:2, about 2:3, or about 1:1. In certain embodiments, the ratio of the inner component to the outer component in the low-moisture pet food composition can be from about 3:2 to about 1:1 or from about 3:7 to about 7:3.

In certain embodiments, the low-moisture pet food composition can include the inner component in an amount of from about 30% to about 70%, about 40% to about 60%, about 40% to about 55%, or about 45% to about 55% by weight, based on the total weight of the low-moisture pet food composition. In particular embodiments, the low-moisture pet food composition can include the inner component in an amount of at least about 40%, at least about 45%, at least about 50%, at least about 55%, or at least about 60% by weight, based on the total weight of the low-moisture pet food composition.

In certain embodiments, the low-moisture pet food composition can include the outer component in an amount of from about 30% to about 70%, about 35% to about 60%, about 40% to about 60%, or about 40% to about 50% by weight, based on the total weight of the low-moisture pet food composition. In particular embodiments, the low-moisture pet food composition can include the outer component in an amount of at least about 40%, at least about 45%, at least about 50%, at least about 55%, or at least about 60% by weight, based on the total weight of the low-moisture pet food composition.

Further, in certain embodiments, the inner component can have a textured surface. In alternative embodiments, the inner component can have a smooth surface. For example, and not by limitation, the amount of inclusion of the inner component can provide the desired texture thereto.

In particular embodiments, the low-moisture pet food composition can include about 65% of the inner component and about 35% of the outer component, about 60% of the inner component and about 40% of the outer component, about 40% of the inner component and about 60% of the outer component, or about 50% of the inner component and about 50% of the outer component by weight, based on the total weight of the low-moisture pet food composition. In certain embodiments, the amount of the inner component can be greater than the amount of the outer component of the low-moisture pet food composition. In such embodiments, an increased amount of the inner component can provide a more open-ended outer component.

### 6.3. Methods of Making Low-Moisture Pet Food Compositions

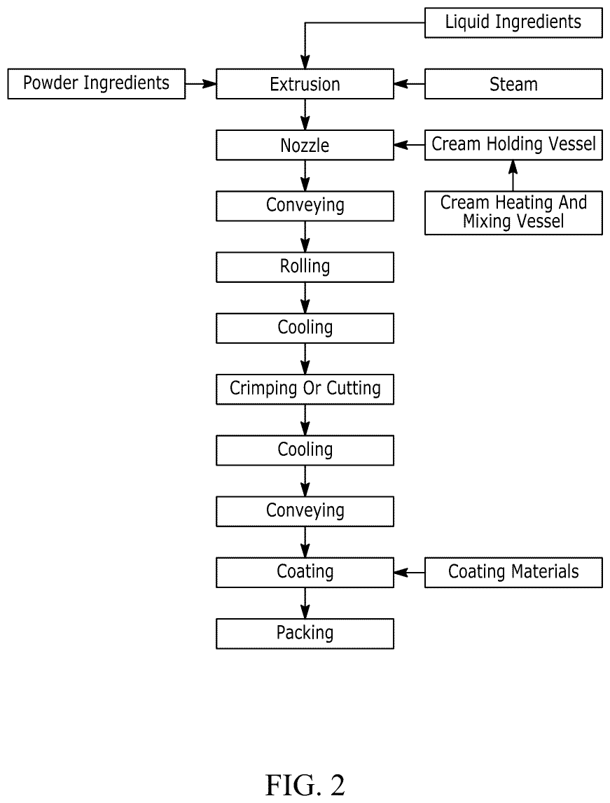

In certain embodiments, a method of manufacturing a low-moisture pet food composition is provided. A variety of processes can be used to provide the low-moisture pet food compositions of the present disclosure. An exemplary process for manufacturing such low-moisture pet food compositions is provided in FIG. 2.

Materials, for example, in powder form for forming an outer component of the low-moisture pet food composition can be provided to an extruder. Additionally or alternatively, a preconditioner can be used to pre-heat the materials by using heat, moisture and time prior to providing the materials to the extruder. In some embodiments, additional moisture can then be added into the process through, for example, water and/or steam. The water and/or steam can be added to the extruder or optionally the preconditioner, if used. The materials can then be extruded on a twin-screw or single-screw extruder and an inner component of the low-moisture pet food composition can be provided from a holding vessel. The dual-component extrudate can then be optionally rolled post-extrusion. In some embodiments, the extrudate is conveyed to a cooling tunnel. The dual-component extrudate then can optionally be conveyed to a crimper or cutter. In certain embodiments, the dual-component extrudate can be crimped with a crimper. In particular embodiments, the dual-component extrudates can be cut with a cutter (e.g., guillotine cutter or other cutting mechanisms). The dual-component extrudate can then be conveyed to a cooling tunnel after being crimped or cut. In some embodiments, cooling is performed only before crimping or cutting. In some embodiments, cooling is performed only after crimping or cutting. In some embodiments, cooling is performed before and after crimping or cutting. In certain embodiments, the dual-component extrudate can be further coated. In particular embodiments, the dual-component extrudate can be coated with a palatability-enhancing coating.

In certain embodiments, the low-moisture pet food composition can include indications of portionability, for example, and not by way of limitation, by crimped indents. In certain embodiments, a bespoke crimp wheel with both cutting and indenting fins can be used. The indenting fins, for example, can form indents if they are above a particular length, of a particular sharpness, and if the low-moisture pet food composition has conditioned for a particular amount of time so as to retain a crimped indent from the indenting fins. In order to avoid or decrease potential loss of the inner component if exceedingly hot and potential damage of the outer component if exceedingly cool, the low-moisture pet food composition should be cut in a certain temperature range.

In certain embodiments, if cutting or crimping is to be performed, the low-moisture pet food composition of the present disclosure can first be rolled, e.g., with an in-line roller, to form an oval shape or the like. Such rolling can be performed within a certain amount of time to ensure the outer component obtains a firmer texture prior to cutting or crimping.

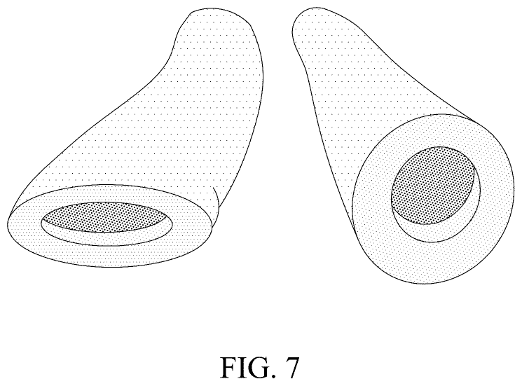

In certain embodiments, a varying end profile can be imparted on the low-moisture pet food compositions of the present disclosure, e.g., by the cutting process of the composition. As shown in FIG. 7, a crimp cut (left) can impart a different end profile to the low-moisture pet food composition in comparison to a guillotine cut (right).

### 6.4. Methods of Using Low-Moisture Pet Food Compositions

Low-moisture pet food compositions of the present disclosure can be used alone as a pet food product. Such end products can include, for example without limitation, a treat end product. With certain active ingredients, such low-moisture pet food compositions can be used in a variety of applications, for example, in oral care or as supplements. Alternatively, the low-moisture pet food composition can be used in combination with other pet food compositions (e.g., kibble) to form a mixed pet food end product.

### 6.5. Features of Low-Moisture Pet Food Compositions

The present disclosure provides for low-moisture pet food compositions. Such compositions can be multi-component compositions having inner and outer components in which the outer component partially covers the inner component. The inner component can be relatively soft (e.g., softer than the outer component) and the outer component can be relatively hard. Thus, low-moisture pet food compositions can have a dual texture.

Low-moisture pet food compositions of the present disclosure can be formed in various shapes. For example, in certain embodiments, the low-moisture pet food composition can be in the shape of a stick. In certain embodiments, the low-moisture pet food composition can have a height to width ratio of from about 20:1 to about 1:1. In some embodiments, the shapes include a longitudinal length and a width, and in certain embodiments the length and the width are different from one another. In certain embodiments, the outer component can partially cover the inner component of the low-moisture pet food composition. For example, and not by limitation, the inner component can be exposed on at least one surface of the low-moisture pet food composition. In particular embodiments, the inner component can be exposed on at least two surfaces. In further embodiments, the low-moisture pet food composition can be exposed on surfaces disposed on opposite ends of the composition such that two sides of the inner component are exposed. Thus, in certain embodiments, the softer inner component of the dual textured food compositions of the present disclosure can be visible.

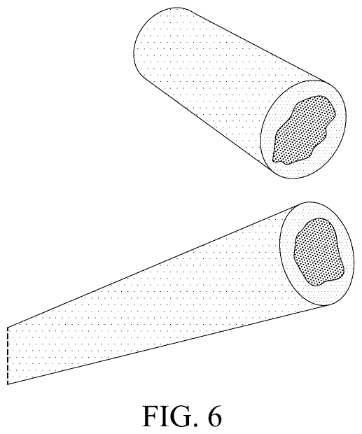

In certain embodiments, low-moisture pet food compositions of the present disclosure can include indications of portionability. In certain embodiments, the overall shape of the low-moisture pet food composition can be oval or cylindrical, e.g., in the form of a stick-like shape. In certain embodiments, the ends of the low-moisture pet food composition can be closed or at least partially open with a visible inner component or filling. For example, as shown in FIG. 6, in certain embodiments, the inner component of the low-moisture pet food composition can be visible when the composition is at least partially broken or torn at the indications of portionability.

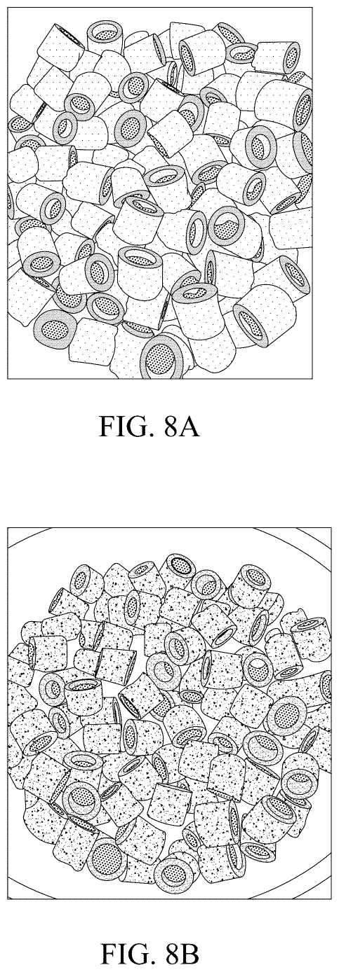

In certain embodiments, the low-moisture pet food composition can have a length of from about 5 mm to 150 mm, 8 mm to about 150 mm, about 25 mm to about 125 mm, or about 50 mm to about 100 mm. In certain embodiments, the low-moisture pet food composition can have a length of at least about 1 mm, at least about 2 mm, at least about 5 mm, at least about 10 mm, at least about 100 mm, or at least about 150 mm. As shown in FIGS. 8A-8B, a non-limiting embodiment of a length of low-moisture pet food compositions of the present disclosure is provided.

In certain embodiments, the low-moisture pet food composition can include one or more segments. In some embodiments, segments include a length between indents that are provided along a longitudinal length of the low-moisture pet food composition. In particular embodiments, the low-moisture pet food composition can include at least one segment, at least two segments, at least three segments, at least four segments, or at least five segments. In certain embodiments, the one or more segments can each have a length of from about 5 mm to 150 mm, 8 mm to about 130 mm, about 10 mm to about 100 mm, or about 15 mm to about 50 mm. In certain embodiments, the one or more segments of the low-moisture pet food composition can have a same length. In certain embodiments, the one or more segments of the low-moisture pet food composition can have different lengths. In certain embodiments, the low-moisture pet food compositions of the present disclosure can have a shape and size which is safe and palatable for animals, such as cats.

Low-moisture pet food compositions of the present disclosure can advantageously have a low final moisture. For example, uncoated pet food compositions of the present disclosure can have a final moisture of less than about 20%, less than about 15%, less than about 10%, from about 3.5% to about 15%, from about 5% to about 12%, from about 8% to about 12%, from about 5% to about 15%, from about 3.5% to about 7.5%, from about 4% to about 6%, or from about 5% to about 7.5%. Uncoated pet food compositions of the present disclosure can have a water activity (Aw) of less than about 0.63, less than about 0.5, less than about 0.4, or less than about 0.3. In particular embodiments, low-moisture pet food compositions of the present disclosure having an inner and outer component can have a water activity (Aw) of from about 0.3 to about 0.45, about 0.3, about 0.35, about 0.4, or about 0.45. Coated pet food compositions of the present disclosure can have a final moisture of from about 5.5% to about 15%, about 5.5% to about 9.5%, about 6% to about 8%, or about 5.5% to about 7%. In particular embodiments, coated pet food compositions of the present disclosure can have a final moisture of less than about 20%, less than about 15%, less than about 10%, about 5.5%, about 6%, about 7%, about 7.5%, about 8%, about 9.5%, about 10%, or about 12%. Coated pet food compositions of the present disclosure can have a water activity (Aw) of less than about 0.65, less than about 0.63, less than about 0.6, less than about 0.55, less than about 0.5, less than about 0.4, or less than about 0.3.

Low-moisture pet food compositions of the present disclosure can advantageously have a texture which provides a composition that can result from a supply chain as intact and can remain edible by animals, e.g., cats. Factors such as relative component recipes, process and product design (e.g., inner component:outer component ratios; presence, number, spacing, and depth of indents) can impact overall texture of such low-moisture pet food compositions. In certain embodiments, a texture of the low-moisture pet food composition can enable the overall composition to be proportioned in a manner than generates minimal mess and/or fines and delivers a safe and edible product for animal consumption.

The following examples are merely illustrative of the presently disclosed subject matter and they should not be considered as limiting the scope of the subject matter in any way.

### Example 1: Low-Moisture Pet Food Compositions—Outer Component (Shell)

This Example provides for outer components such as cereal-based shells prepared in accordance with the present disclosure as Compositions 1-5. Such outer components advantageously can have a low final moisture content and can be used with inner components, for example, as provided in Examples 2 and 7, to form dual textured pet food compositions of the present disclosure.

Table 2 provides the ingredients and their proportions of Compositions 1-3.

TABLE 2
Compositions 1-3 Formulation

| | Composition | Composition | Composition |
|---|---|---|---|
| | 1 | 2 | 3 |
| Ingredient | (wt.-%) | (wt.-%) | (wt.-%) |
| Poultry Material | — | 36 | 45 |
| Corn | — | 40 | 36 |
| Rice | — | 17 | 14 |
| Yeast | — | 5 | 5 |
| Salt | 2 | 2 | 0.40 |
| Liver Powder | 18 | — | — |
| Corn | 36 | — | — |
| Soy Flour | 35 | — | — |
| Wheat Gluten | 8 | — | — |
| Vitamins/minerals/ | 1 | — | — |
| antioxidants/colors | | | |
| Total | 100.00 | 100.00 | 100.00 |

Table 3 provides the ingredients and their proportions of Composition 4.

TABLE 3
Composition 4 Formulation

| Ingredient | wt.-% |
|---|---|
| Poultry Material | 45 |
| Corn | 33 |
| Rice | 14 |
| Yeast | 5 |
| Vitamins/minerals/ | 3 |
| antioxidants/colors | |
| Flavors | ~0.1 |
| Total | 100.00 |

Table 4 provides the ingredients and their proportions of Composition 5.

TABLE 4
Composition 5 Formulation

| Ingredient | wt.-% |
|---|---|
| Poultry Material | 20 |
| Pea Protein | 8 |
| Corn Gluten | 6 |
| Maize Flour | 32 |
| Soy Flour | 28 |
| Vitamins/minerals/ | 6 |
| antioxidants/colors | |
| Total | 100.00 |

### Example 2: Low-Moisture Pet Food Compositions-Inner Component (Filling)

This Example provides for inner components such as cream-based fillings prepared in accordance with the present disclosure as Compositions 6-20. Such inner components advantageously can have a high viscosity and can be used with outer components, for example, as provided in Example 1, to form dual textured pet food compositions of the present disclosure.

Table 5 provides the ingredients and their proportions of Compositions 6-13.

TABLE 5
Compositions 6-13 Formulation

| | Compo- | Compo- | Compo- | Compo- |
|---|---|---|---|---|
| | sition 6 | sition 7 | sition 8 | sition 9 |
| Ingredient | (wt.-%) | (wt.-%) | (wt.-%) | (wt.-%) |
| Animal | 40.00 | — | — | — |
| and/or | | | | |
| non-animal | | | | |
| protein | | | | |
| Wheat Flour | 16 | 4 | 42 | 40 |
| Beef Tallow | 44 | 56 | 58 | 60 |
| Total | 100.00 | 100.00 | 100.00 | 100.00 |

| | Compo- | Compo- | Compo- | Compo- |
|---|---|---|---|---|
| | sition 10 | sition 11 | sition 12 | sition 13 |
| Ingredient | (wt.-%) | (wt.-%) | (wt.-%) | (wt.-%) |
| Animal | 5.00 | 15.00 | 25.00 | 30.00 |
| and/or | | | | |
| non-animal | | | | |
| protein | | | | |
| Wheat Flour | 44 | 42 | 42 | 42 |
| Beef Tallow | 51 | 43 | 38 | 28 |
| Total | 100.00 | 100.00 | 100.00 | 100.00 |

Table 6 provides the ingredients and their proportions of Compositions 14-20.

TABLE 6
Compositions 14-20 Formulation

| | Compo- | Compo- | Compo- | Compo- |
|---|---|---|---|---|
| | sition 14 | sition 15 | sition 16 | sition 17 |
| Ingredient | (wt.-%) | (wt.-%) | (wt.-%) | (wt.-%) |
| Animal | 20.00 | 10.00 | 20.00 | — |
| and/or | | | | |
| non-animal | | | | |
| protein | | | | |
| Wheat Flour | 40.00 | 40.00 | 40.00 | 40.00 |
| Beef Tallow | 20.00 | 20.00 | 20.00 | — |
| Pre-Gel | 20.00 | 30.00 | — | — |
| Wheat Starch | | | | |
| Wheat Gluten | — | — | — | — |
| Maltodextrin | — | — | 20.00 | 20.00 |
| Collagen | — | — | — | — |
| Peptides | | | | |
| Pea Protein | — | — | — | 40.00 |
| Total | 100.00 | 100.00 | 100.00 | 100.00 |

| | Compo- | Compo- | Compo- |
|---|---|---|---|
| | sition 18 | sition 19 | sition 20 |
| Ingredient | (wt.-%) | (wt.-%) | (wt.-%) |
| Animal | — | — | — |
| and/or | | | |
| non-animal | | | |
| protein | | | |
| Wheat Flour | 44 | 44 | 42 |
| Beef Tallow | 16 | 36 | 29 |
| Pre-Gel | — | — | — |
| Wheat | | | |
| Starch | | | |
| Wheat | — | — | 29 |
| Gluten | | | |
| Maltodextrin | — | — | — |
| Collagen | 40 | 20 | — |
| Peptides | | | |
| Pea Protein | — | — | — |
| Total | 100.00 | 100.00 | 100.00 |

### Example 3: Low-Moisture Pet Food Compositions

This Example provides for low-moisture pet food compositions of the present disclosure. Table 7 provides the ingredients and their proportions of Sample A.

TABLE 7
Sample A Formulation

| Component | Ingredient | wt.-% |
|---|---|---|
| Shell | Potato Starch | 4 |
| | Poultry Liver Powder | 3 |
| | Soya | 32 |
| | Salt | ~1 |
| | Calcium Carbonate | ~1 |
| | Gluten | ~3 |
| Cream | Beef Tallow | 22 |
| | Animal and/or non- | 6 |
| | animal protein | |
| | Wheat Flour | 23 |
| Coating | Digest Palatant and | 5 |
| | Beef Tallow | |

Table 8 provides the ingredients and their proportions of Sample B.

TABLE 8
Sample B Formulation

| Component | Ingredient | wt.-% |
|---|---|---|
| Shell | Poultry Material | 1 |
| | Corn | 13 |
| | Poultry Liver Powder | 6 |
| | Salt | ~1 |
| | Calcium Carbonate | ~1 |
| | Soya Fines | 13 |
| | Gluten | 3 |
| Cream | Beef Tallow | 24 |
| | Animal and/or non- | 22 |
| | animal protein | |
| | Wheat Flour | 9 |
| Coating | Palatant and | 7 |
| | Beef Tallow | |

### Example 4: Palatability Testing (Samples A and C)

This Example provides for palatability testing of low-moisture pet food compositions of the present disclosure. Sample A was tested for palatability in comparison to a control composition (hereinafter “Control A”). Sample A included two sides having an exposed inner cream component. An outer component, Composition 1 (hereinafter “Sample C”), was also tested for palatability against Control A. Palatability tests were conducted. Cats (n=30) were exposed to both samples. Both samples were offered to each cat for approximately 20 minutes. The samples were offered in excess in order to enable the assessment in differences in feeding performance. The cats were exposed to both samples a total of four (4) times and the location of the samples were rotated with each exposure to ensure there was no bias due to product order or day effect.

The ingredients and their proportions of Control A are provided in Table 9.

TABLE 9
Control A Formulation

| Ingredient | wt.-% |
|---|---|
| Poultry Meal | 29 |
| Corn | 21 |
| Beef Tallow | 15 |
| Animal and/or non- | 10 |
| animal protein | |
| Rice | 9 |
| Wheat Flour | 7 |
| Yeast | 3 |
| Vitamins/minerals/ | 2 |
| antioxidants/colors | |
| Digest Palatant | ~4 |
| Antioxidant | ~0.01 |

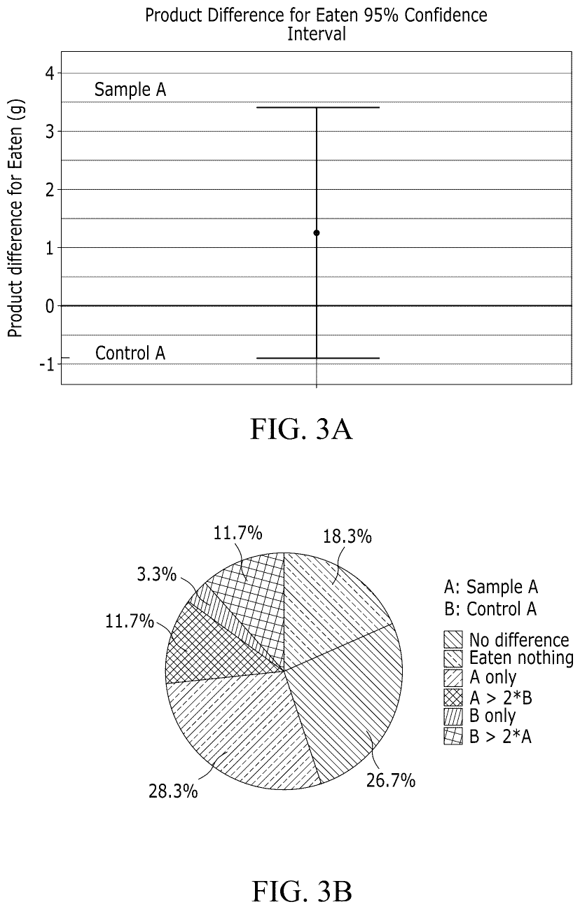

The results for the palatability testing of Sample A are provided in FIGS. 3A and 3B. As shown in FIG. 3A, Sample A can perform at least comparable to Control A in providing palatable pet food compositions. Further, as shown in FIG. 3B, 28.3% of cats only ate Sample A and 11.7% of cats ate Sample A at two times the amount of Control A.

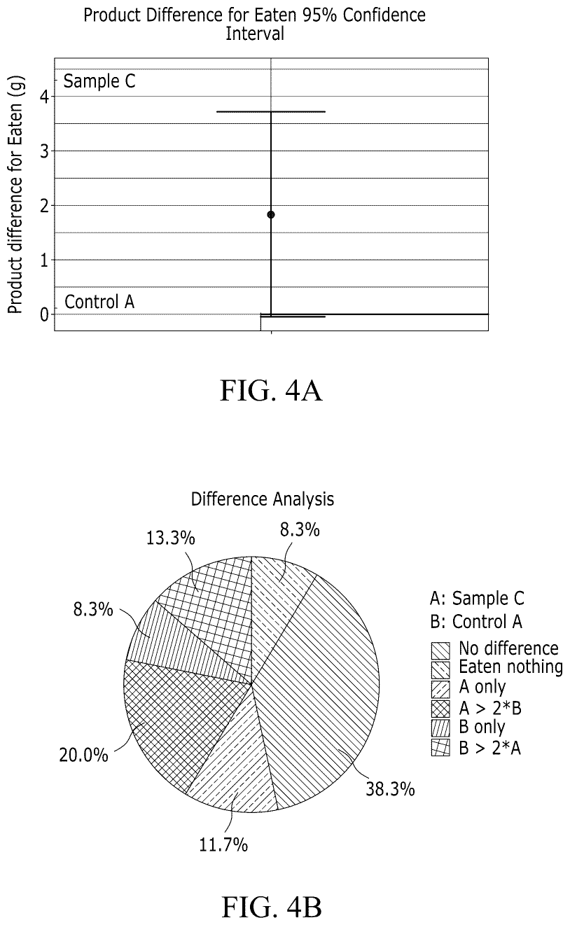

The results for the palatability testing of Sample C are provided in FIGS. 4A and 4B. Products in different formats (i.e., an outer component (Sample C) and an outer component with inner component and coating (Control A) were tested, and palatability was assessed. As shown in FIG. 4B, 11.7% of cats only ate Sample C and 20% of cats ate Sample C at two times the amount of Control A. Further, a directional preference was observed for Sample C (p=0.066) as shown in FIG. 4A. Such results suggest outer components as provided in Sample C can be used in products to deliver high levels of palatability.

### Example 5: Palatability Testing (Sample B)

This Example provides for palatability testing of low-moisture pet food compositions of the present disclosure. Sample B was tested for palatability in comparison to a control composition (hereinafter “Control B”). Sample B included two sides having an exposed inner cream component. Palatability tests were conducted in accordance with Example 4. Cats (n=29) were exposed to both samples.

The ingredients and their proportions of Control B are provided in Table 10.

TABLE 10
Control B Formulation

| Ingredient | wt.-% |
|---|---|
| Poultry Material | 29 |
| Corn | 22 |
| Rice | 10 |
| Yeast | 3 |
| Salt | ~0.2 |
| Beef Tallow | 12 |
| Animal and/or non- | 10 |
| animal protein | |
| Wheat Flour | 7 |
| Beef Tallow | 3 |
| Digest Palatant | ~4 |

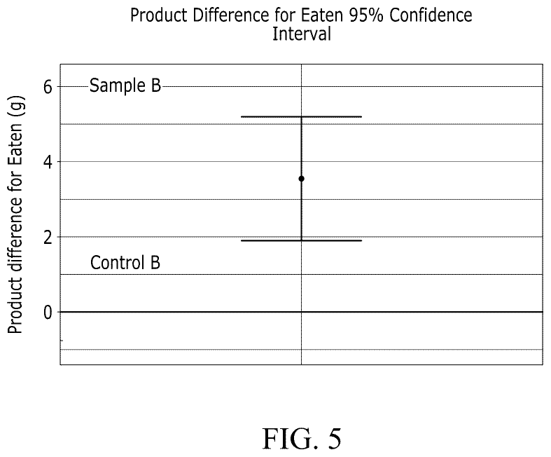

The results for the palatability testing of Sample B are provided in Tables 11-12 and FIG. 5.

TABLE 11
Intake Difference Test Results (Sample B)

| | Difference | 95% | 95% | Standard | p- |
|---|---|---|---|---|---|
| Contrast | (g) | Lower | Upper | Error | value |
| Sample B − | 3.54 | 1.89 | 5.19 | 0.84 | 0.0002 |
| Control B | | | | | |

TABLE 12
Product Means Results (Sample B)

| Variable | Sample B | Control B | p-value |
|---|---|---|---|
| Mean Intake (g) | 11.95 | 8.36 | 0.0002 |
| Meals | 58 | 58 | |
| Cats | 29 | 29 | |

As shown in Table 11, there was an intake different of 3.54 g of Sample B as compared to Control B. As shown in Table 12, the mean intake of Sample B at 11.95 g was greater than the mean intake of Control B. As shown in FIG. 5, a significant difference was determined between the products was determined at the 5% level. Sample B was found to be significantly more palatable than the Control B formulation.

### Example 6: Low-Moisture Pet Food Compositions—Outer Component (Shell)

This Example provides for outer components such as cereal-based shells prepared in accordance with the present disclosure as Composition 21. Such outer components advantageously can have a low final moisture content and can be used with inner components, for example, as provided in Examples 2 and 7, to form dual textured pet food compositions of the present disclosure.

Table 13 provides the ingredients and their proportions of Composition 21.

TABLE 13

| | Composition 21 |
|---|---|
| Ingredient | (wt.-%) |
| Corn | 40 |
| Poultry Material | 36 |
| Sodium Chloride | 2.00 |
| Yeast | 5.00 |
| Rice Flour | 17 |

### Example 7: Low-Moisture Pet Food Compositions—Inner Component (Filling)

This Example provides for inner components such as cream-based fillings prepared in accordance with the present disclosure as Compositions 22-23.

Table 14 provides the ingredients and their proportions of Composition 22.

TABLE 14

| | Composition 22 |
|---|---|
| Ingredient | (wt.-%) |
| Animal and/or non- | ~36.54 |
| animal protein | |
| Wheat Flour | ~17.0 |
| Beef Tallow | ~43.5 |

Table 15 provides the ingredients and their proportions of Composition 23.

TABLE 15

| | Composition 23 |
|---|---|
| Ingredient | (wt.-%) |
| Animal and/or non- | 27 |
| animal protein | |
| Wheat Flour | 0 |
| Beef Tallow | 43 |
| Maltodextrin | 30 |

### Example 8: Low-Moisture Pet Food Compositions-Coating

This Example provides for coatings in accordance with the present disclosure as Composition 24.

Table 16 provides the ingredients and their proportions of Composition 24.

TABLE 16

| | Composition 24 |
|---|---|
| Ingredient | (wt.-%) |
| Beef Tallow | 41 |
| Digest Palatant | 59 |

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

Various patents and patent applications are cited herein, the contents of which are hereby incorporated by reference herein in their entireties.

What is claimed is:

1. A multi-component pet food composition comprising:
an inner component comprising:
one or more fat sources in an amount of from about 0% to about 60% by weight;
one or more protein sources in an amount of from about 0% to about 40% by weight; and
one or more carbohydrate sources in an amount of from about 15% to about 70% by weight, based on the total weight of the inner component; and
an outer component partially covering the inner component, the outer component having a total moisture content of from about 1% to about 15% and a water activity of less than about 0.75.

2. The multi-component pet food composition of claim 1, wherein the outer component has a total moisture content of from about 6% to about 10%.

3. The multi-component pet food composition of claim 1, wherein the inner component and the outer component are present in a ratio of from about 7:3 to about 3:7.

4. The multi-component pet food composition of claim 1, wherein the inner component is exposed on at least two surfaces of the pet food composition.

5. The multi-component pet food composition of claim 1, wherein the pet food composition has a water activity of less than about 0.65.

6. The multi-component pet food composition of claim 1, wherein the one or more fat sources comprises beef tallow.

7. The multi-component pet food composition of claim 1, wherein the one or more protein sources comprises animal, non-animal protein, or combinations thereof.

8. The multi-component pet food composition of claim 1, further comprising a coating disposed on at least a portion of the outer component.

9. The multi-component pet food composition of claim 1, wherein the composition comprises at least two segments.

10. The multi-component pet food composition of claim 1, wherein the composition has a length of from about 5 mm to about 150 mm.

11. A pet food product comprising the multi-component pet food composition of claim 1.

12. A method of making a low-moisture pet food composition, the method comprising: extruding the materials to form an outer component; introducing an inner component to form a dual-component extrudate; conveying the dual-component extrudate to a cooling tunnel; and cutting and coating the extrudate to form the low-moisture pet food composition.

13. The method of claim 12, wherein the outer component, after the extruding step and before the introducing step, includes a moisture content of about less than about 20%, by weight of the outer component.

14. The method of claim 12, wherein the method does not include a step of drying the outer component or the dual-component extrudate.
